(19) United States
(12) Patent Application Publication
(10) Pub. No.: US 2008/0107904 A1
(43) Pub. Date: May 8, 2008

(54) Hydroxyl-Containing Resin Composition for Coating Materials, Coating Composition, Coating Finishing Method, and Coated Article

(75) Inventors: Tetsu Konishi, Kanagawa (JP); Rui Niimi, Munster (DE); Yuichi Shinozaki, Kanagawa (JP)

Correspondence Address: BASF CORPORATION;Patent Department, 1609 BIDDLE AVENUE, MAIN BUILDING, WYANDOTTE, MI, 48192, US

(73) Assignee: BASF COATINGS JAPAN LTD, Yokohama-shi, Kanagawa (JP)

(21) Appl. No.: 11/576,841

(22) PCT Filed: Oct. 5, 2005
(86) PCT No.: PCT/IB05/02978

§ 371 Date: Apr. 6, 2007

(30) Foreign Application Priority Data
Oct. 8, 2004 (JP) 2004-296969

(51) Int. Cl. B32B 27/00; C08G 65/34

(52) U.S. Cl. 428/411.1; 528/425

(57) ABSTRACT

The present invention relates to a hydroxyl-containing resin composition for a coating material, characterized in comprising a hydroxyl-containing resin that has a hydroxyl value of 50 to 400 mg KOH/g and a weight-average molecular weight of 2,000 to 100,000, and in being a resin obtained by copolymerizing, in the presence of (a) an acid compound containing one carboxyl group and two or more hydroxyl groups, (b) a radical-polymerizable monomer having an epoxy group and (c) another radical-polymerizable monomer, or a resin obtained by the addition reaction of (a) an acid compound containing one carboxyl group and two or more hydroxyl groups with a copolymer of (b) a radical-polymerizable monomer having an epoxy group and (c) another radical-polymerizable monomer. The invention also relates to a coating composition comprising the resin composition and a crosslinking agent, to a coating finishing method in which the coating composition is used, and to a coated article coated by the method.

### TECHNICAL FIELD

The present invention relates to a novel hydroxyl-containing resin composition for a coating material, a coating composition, a finish coating method, and a coated article. In further detail, the present invention relates to a resin for a coating material with which it is possible to obtain excellent painting performance in the field of automobile painting and produce a paint film having excellent appearance, particularly appearance by wet-on-wet painting of a base coat and a clear coat, as well as acid rain resistance, car-washing damage resistance, solvent resistance, water resistance and weather resistance, and also relates to a coating composition, a finishing coating method, and a coated article.

### BACKGROUND ART

Coating compositions comprising a hydroxyl-containing acrylic resin and a crosslinking agent having functional groups that will react with hydroxyl groups are often used in the automobile painting industry. The hydroxyl-containing acrylic resins used in these coating compositions have primarily been copolymers of a radical polymerizable monomer having hydroxyl groups and another radical polymerizable monomer, but resins having a high hydroxyl value have recently become necessary because of the demand in the field of automobile painting for a coating material, particularly a clear coating, having acid rain resistance and car-washing damage resistance.

For instance, a hydroxyl-containing resin known in the art is obtained by causing an alkanoic acid monoglycidyl ester and a 2,2-dimethylolalkanoic acid having 6 to 8 carbons to undergo ester addition (for instance, refer to Patent Reference 1).

However, this hydroxyl-containing resin is provided with a low molecular weight with the objective of using little or no solvent, and poses a disadvantage in that when the resin is used as a base resin for automotive coatings, it is impossible to obtain adequate durability.

Moreover, a high-solid-content resin composition is known that is characterized in being the product of a carboxyl-containing compound and an epoxy-containing compound, and in that the composition comprises a hydroxyl-containing compound having a weight-average molecular weight of 1,000 or less and a hydroxyl value of 200 to 800, a polyisocyanate compound, and a melamine resin (for instance, refer to Patent Reference 2).

Nevertheless, the method of wet-on-wet coating of a base coat material and a clear coating material normally used as automotive coatings is disadvantageous in that when the resin has a weight-average molecular weight of 1,000 or less, there is insufficient separation of the two layers, the coatings mix at the interface between the top and bottom layers, and a good paint film appearance is not obtained.

In general, when the hydroxyl value of a resin increases, the polarity of the resin rises, there is a reduction in compatibility with low-polarity solvents, and a high-polarity solvent must be used as a diluting solvent. In this case as well there is a disadvantage in that separation from the base coat is reduced. Moreover, because the resin polarity is high, compatibility with crosslinking agents is impaired, resulting in poor appearance and restrictions in terms of the crosslinking agents that can be used, and it is difficult to realize both good appearance and other properties. Designing a resin with a low hydroxyl value has a drawback in that it is difficult to provide adequate properties, including acid rain resistance, car-washing damage resistance, and solvent resistance.

[Reference 1] JP (Kokai) 2003-055313

[Reference 2] JP (Kokai) 2002-348529

### DISCLOSURE OF THE INVENTION

Problems to be Solved by the Invention

The present invention provides a hydroxyl-containing resin composition for a coating material that contains a hydroxyl value [sic], has low polarity, and makes it possible to obtain a film having excellent coating performance and excellent appearance, particularly appearance by wet-on-wet coating with a base coat, as well as excellent acid rain resistance, car-washing damage resistance, solvent resistance, water resistance, and weather resistance; and also provides a coating composition, coating finishing method, and coated article that use this hydroxyl-containing resin composition for a coating material.

Means for Solving Problems

As a result of conducting intense research to solve the above-mentioned problems, the inventors discovered that the aforesaid object can be accomplished by using a hydroxyl-containing resin composition for a coating material obtained by copolymerizing, in the presence of (a) an acid compound containing one carboxyl group or two or more hydroxyl groups, (b) a radical polymerizing monomer and (c) another radical polymerizable monomer, or by using a hydroxyl-containing resin composition for a coating material obtained by addition reaction of (a) an acid compound containing one carboxyl group or two or hydroxyl groups with (b) a copolymer of radical polymerizable monomer having epoxy groups and (c) another radical polymerizable monomer, and successfully completed the present invention based on this knowledge.

In essence, the present invention provides a hydroxy-containing resin composition for a coating material characterized in comprising a hydroxyl-containing resin that has a hydroxyl value of 50 to 400 mg KOH/g and a weight-average molecular weight of 2,000 to 100,000, and in being obtained by copolymerizing, in the presence of (a) an acid compound containing one carboxyl group and two or more hydroxyl groups, (b) a radical polymerizable monomer having an epoxy group and (c) another radical polymerizable monomer.

The present invention also provides a hydroxyl-containing resin composition for a coating material characterized in comprising a hydroxyl-containing resin that has a hydroxyl value of 50 to 400 mg KOH/g and a weight-average molecular weight of 2,000 to 100,000, and in being obtained by the addition reaction of (a) an acid compound containing one carboxyl group and two or more hydroxyl groups with a copolymer of (b) a radical polymerizable monomer having an epoxy group and (c) another radical polymerizable monomer.

The present invention further provides a hydroxy-containing resin composition for a coating material wherein the acid compound containing one carboxyl group and two or more hydroxyl groups in the above-mentioned hydroxyl-containing resin composition for a coating material is 2,2-dimethylolbutanoic acid or 2,2-dimethylolpropionic acid.

The present invention also provides a hydroxy-containing resin composition for a coating material, where (d) a lactone compound is caused to undergo an addition reaction in an amount of less than 100 parts by mass with the hydroxyl groups of 100 parts by mass of the hydroxyl-containing resin of the above-mentioned hydroxyl-containing resin composition for a coating material.

The present invention further provides a coating composition characterized in comprising the above-mentioned hydroxyl-containing resin composition for a coating material and a crosslinking agent in which at least one or more functional groups that react with hydroxyl groups is contained in each molecule.

The present invention provides a coating finishing method characterized in the application of the above-mentioned hydroxyl-containing resin composition for a coating material, and a coated article coated by the above-mentioned coating finishing method.

Effect of the Invention

The coating composition of the present invention forms a film having excellent coating performance, particularly excellent appearance by wet-on-wet coating with a base coat, as well as excellent acid rain resistance, car-washing damage resistance, solvent resistance, water resistance, and weather resistance. Moreover, the coating finishing method that uses the coating composition of the present invention produces excellent appearance, and the coated article has excellent film properties.

### BEST MODE FOR CARRYING OUT THE INVENTION

An acid compound containing one C₅-C₁₀ carboxyl group and two or more hydroxyl groups is preferred as the acid compound containing one carboxyl group and two or more hydroxyl groups. This compound is component (a) and is used for obtaining the hydroxyl-containing resin composition for a coating material of the present invention. The number of carbon atoms in this acid compound is particularly within a range of 5 to 8, and is ideally 5 or 6. The upper limit of the number of hydroxyl groups is preferably 5 or less, particularly 3 or less. Specific preferred examples of the acid compound of component (a) include 2,2-dimethylolubutanoic acid and 2,2-dimethylolpropionic acid. Among these, 2,2-dimethylolbutanoic acid is particularly preferred from the standpoint of obtaining a resin of a lower polarity.

The acid compound of component (a) imparts hydroxyl groups to the resin through an addition reaction with a radical polymerizable monomer having epoxy groups. This monomer is component (b). This addition reaction between the acid compound of component (a) and the epoxy groups of component (b) can be performed before, during, or after completion of copolymerization of the monomer of component (b) and the monomer of component (c).

The amount in which acid compound of component (a) is added depends on the amount of component (b) and the hydroxyl value of the resin, and is preferably 1.2 times or less the amount of epoxy groups in component (b) when expressed as a molar ratio. A molar ratio of the acid of component (a) that is greater than 1.2 times the amount of epoxy groups is undesirable because there are cases in which unreacted acid precipitates in the resin. There are no special restrictions to the lower limit of the amount in which the acid compound of component (a) is added, but it preferably accounts for 5 mass % or more of the resin solid content. If there is an excess of carboxyl groups in the acid compound of component (a) in relationship to the epoxy groups in component (b), the excess carboxyl groups of the acid compound of component (a) cannot react with the epoxy groups in component (b), and the acid compound of component (a) that does not have polymerizable double bonds may be present unreacted in the hydroxyl-containing resin composition for a coating material of the present invention. On the other hand, when there is an excess of epoxy groups of component (b) in relationship to the carboxyl groups of the acid compound of component (a), the resulting hydroxyl-containing resin compound may have epoxy groups.

Moreover, the radical polymerizable monomer having epoxy groups, which is component (b) and is used to obtain the hydroxyl-containing resin composition for a coating material of the present invention, is a radical polymerizing monomer having epoxy groups and one or more radical-polymerizing carbon-carbon double bond. The number of carbon-carbon double bonds is preferably two or less, particularly one or less. Component (b) may have functional groups other than epoxy groups, but groups that do not react with the hydroxyl and carboxyl groups of component (a) are preferred, and a component that does not have functional groups other than epoxy groups is particularly preferred. Specific examples of component (b) are glycidyl acrylate, glycidyl methacrylate, 3,4-epoxycyclohexylmethyl acrylate, 3,4-epoxycycyclohexylmethyl methacrylate and the like, and one or a mixture of two or more of these compounds can be used.

It is preferred that the hydroxyl value of the hydroxyl-containing resin be within a range of 50 to 400 mg KOH/g, and particularly 100 to 300 mg KOH/g, in order to obtain excellent cured film appearance, solvent resistance, water resistance, and weather resistance. A hydroxyl value that is less than 50 is undesirable because there is a reduction in acid rain resistance, car-washing damage resistance, solvent resistance and weather resistance, and a value that exceeds 400 is undesirable because that there is a reduction in compatibility and in appearance.

Specific examples of the other radically polymerizable monomer, which is component (c) and is used to obtain a hydroxyl-containing resin composition for a coating material of the present invention, are methyl acrylate, ethyl acrylate, n-propyl acrylate, isopropyl acrylate, n-butyl acrylate, isobutyl acrylate, sec-butyl acrylate, hexyl acrylate, cyclohexyl acrylate, 2-ethylhexyl acrylate, octyl acrylate, lauryl acrylate, stearyl acrylate, methyl methacrylate, ethyl methacrylate, n-propyl methacrylate, isopropyl methacrylate, n-butyl methacrylate, isobutyl methacrylate, sec-butyl methacrylate, hexyl methacrylate, cyclohexyl methacrylate, 2-ethylhexyl methacrylate, octyl methacrylate, lauryl methacrylate, stearyl methacrylate, styrene, acrylonitrile, methacrylonitrile, acrylamide and methacrylamide, and one or a mixture of two or more of these can be used.

Furthermore, the hydroxyl groups produced by reaction of component (a) and component (b), and the hydroxyl groups from a radically polymerizable monomer having hydroxyl groups can be jointly used in the hydroxyl-containing resin composition for a coating material of the present invention.

Examples of radically polymerizable monomers having hydroxyl groups include 2-hydroxyethyl acrylate, 2-hydroxypropyl acrylate, 3-hydroxypropyl acrylate, 4-hydroxybutyl acrylate, 2-hydroxyethyl methacrylate, allyl alcohol, addition products of acrylic acid and versatic acid glycidyl ester, and addition products of methacrylic acid and versatic acid glycidyl ester; ε-caprolactone addition products of 2-hydroxyethyl acrylate, 2-hydroxypropyl acrylate, 3-hydroxypropyl acrylate, 4-hydroxybutyl acrylate, 2-hydroxyethyl methacrylate, 2-hydroxypropyl methacrylate, 3-hydroxypropyl methacrylate, and 4-hydroxybutyl methacrylate; and ethylene oxide and/or propylene oxide addition products of 2-hydroxyethyl acrylate, 2-hydroxypropyl acrylate, 3-hydroxypropyl acrylate, 4-hydroxybutyl acrylate, 2-hydroxyethyl methacrylate, 2-hydroxypropyl methacrylate, 3-hydroxypropyl methacrylate, and 4-hydroxybutyl methacrylate.

The lactone compound used as component (d) for obtaining the hydroxyl-containing resin composition for a coating material of this invention is incorporated in the resin by a ring-opening addition reaction with the hydroxyl groups of the hydroxyl-containing resin. The lactone modification imparts rubber-like elasticity to the cured film formed from the coating composition in which the hydroxyl-containing resin is used, particularly a clear coating composition, and high car-washing damage resistance is achieved.

Examples of such lactone compounds include β-methyl-δ-valerolactone, γ-valerolactone, δ-valerolactone, δ-caprolactone, γ-caprolactone, ε-caprolactone, β-propiolactone, γ-butyrolactone, γ-nonamoic lactone and δ-dodecanolactone. Of these, ε-caprolactone is particularly preferred. One of these lactone compounds can be used alone, or a combination of two or more types can be used.

Furthermore, the addition reaction method used for this lactone compound can involve an addition reaction of the lactone compound with the hydroxyl groups with the compound of component (a), followed by copolymerizing (b) a radically polymerizable monomer having epoxy groups and (c) the other radically polymerizable monomer, or by the addition reaction of the lactone compound following an addition reaction of the acid of the compound of component (a) with the copolymer of (b) a radically polymerizable monomer having epoxy groups and (c) the other polymerizable monomer.

The lactone compound is preferably used in an amount of less than 100 parts by mass, preferably within a range of 0 to 50 parts by mass, and ideally within a range of 5 to 45 parts by mass, per 100 parts by mass of hydroxyl-containing resin obtained from components (a), (b), and (c). If the lactone compound content is 100 parts by mass or greater, the cured film that is eventually obtained will be too soft, and the appearance, solvent resistance, water resistance and weather resistance of the cured film will be inferior.

The weight-average molecular weight of the hydroxyl-containing resin of the present invention is 2,000 to 100,000 preferably 3,000 to 30,000. A weight-average molecular weight that is less than 2,000 is undesirable in terms of wet-on-wet coating with a base coat in that the layer will tend to mix with the base coat component and the film appearance will be compromised, while a weight-average molecular weight that exceeds 100,000 is undesirable because compatibility and film appearance will be compromised.

The hydroxyl group-containing resin in the coating composition obtained using the hydroxyl-containing resin composition for a coating material of the present invention is preferably used within a range of 5 to 95%, particularly 30 to 85%, in terms of the solid content of the component used together with the cross-linking agent in which at least one or more functional groups that will react with hydroxyl groups are contained in each molecule.

Examples of cross-linking agents in which at least one or more functional groups that react with hydroxyl groups are contained in each molecule and which are used in the coating composition of the present invention include crosslinking resins having functional groups such as isocyanate groups and blocked isocyanate groups, and melamine resins. These can be used alone, or a combination of two or more can be used. It is preferred that each molecule of the crosslinking agent have two or more, particularly three or more, functional groups that will react with hydroxyl groups.

The coating composition of the present invention can be used alone of after optionally adding organic solvents; various additives such as UV absorbers, photostabilizers, and antioxidants, surfactants, surface modifiers, curing catalysts, antistatics, fragrances, and dehydrating agents; and rheology modifiers such as polyethylene wax, polyamide wax, or internally crosslinked fine resin particles.

It is particularly preferred that the coating composition of the present invention be used as a clear coating composition.

Examples of coating finishing methods using the clear coating composition of the present invention include the two-coat-one-bake coating finishing method wherein a colored base coat is applied to a substrate and the clear coating composition is applied as an uncrosslinked clear coating material; the over-coating finish-painting method wherein a colored base coat is applied to a substrate, an uncrosslinked clear paint composition is applied, the two applications are simultaneously dried, and then the clear coating composition is applied and dried as the clear overcoat material; and the coating finishing method whereby a transparent primer material is applied in order to guarantee close adhesion with the underlying clear coat, and the clear coating composition that is left uncrosslinked is applied as a clear overcoat material.

The colored base coating material, clear coating material, clear overcoat material, and transparent primer material are applied using, for instance, a conventional painting device such as an air sprayer, electrostatic air sprayer, roll coater, flow coater, or a painting device based on a dipping system, or a brush, a bar coater, an applicator or the like after the material has been brought to a predetermined viscosity by heating and adding an organic solvent or reactive diluting solvent as needed. Of these, spray application is preferred.

Examples of substrates coated by the coating composition of the present invention include organic and inorganic materials such as wood, glass, metals, cloth, plastics, foams, elastomers, paper, ceramics, concrete, and plaster board. These substrates may be subjected to a surface pretreatment, or the film may be pre-formed on the surface.

Examples of coated articles obtained using the coating composition of the present invention include structures, wood products, metal products, plastic products, rubber products, finished paper, ceramic products, and glass products. Specific examples include automobiles, automobile parts (for example, the body, bumper, spoiler, mirror, wheels, and interior parts, each made of various materials), metal sheets such as steel sheets, bicycles, bicycle parts, roadside parts (for example, guard rails, traffic signs, and sound deadening walls), tunnel parts (for example, side wall plates), ships, railway rolling stock, domestic goods, musical instruments, domestic electrical appliances, building materials, containers, office appliances, sporting goods and toys.

### WORKING EXAMPLES

The present invention will now be explained in more specific terms with working examples, but the present invention is in no way restricted to these working examples. The properties of the film obtained from the clear composition of the present invention were found as follows:

(1) Coating Material Turbidity Test

Turbidity was evaluated by macroscopic evaluation in accordance with the following criteria:
◯: No turbidity of coating material observed
Δ: Slight turbidity of coating material observed
x: Extreme turbidity of coating material observed

(2) Appearance

Appearance was evaluated by macroscopic observation in accordance with the following criteria:
◯: A fluorescent lamp shining on the film was clearly reflected in the film
Δ: The periphery (outline) of a fluorescent lamp shining on the film was somewhat blurred.
x: The periphery (outline) of a fluorescent lamp shining on the film was very blurred.

(3) Acid Rain Resistance

Acid rain resistance; Spots were made on the film of a test sheet using 0.2 mL of aqueous 40% sulfuric acid, the sheet was heated for 15 minutes at 60° C., then the sheet was rinsed with water, and the extent of staining on the film was macroscopically observed.
◯: Virtually no change seen in film
Δ: Faint water stain seen in film
x: Obvious water stain seen in film

4) Car-Washing Damage Resistance

Scratching Resistance: A brush was used to apply dirty water (JIS Z-8901-84, a mixture of grade 8 dust/water/neutral detergent=10/99/1 by weight ratio) to the film of a test sheet, the car-washing brush of an automobile washing machine was rolled over the piece for 10 seconds at 150 rpm, and the test piece was then rinsed under running water. This operation was repeated twice and the extent of scratching of the film surface of the test piece was determined using the L* values measured by a color difference meter (CR-331 produced by the Minolta Camera Co.). The ΔL* value was calculated using the following equation, and scratching resistance was evaluated based on this value.

ΔL* Value=L* value after testing−* value before testing
◯: ΔL* value was less then 3
Δ: ΔL* value was 3 or greater, but less than 4
x: ΔL* value was 5 or greater.

(5) Solvent Resistance

Changes in the film when gauze moistened with xylene that run back and forth ten times over the film under a weight of approximately 1 kgf were evaluated by macroscopic observation in accordance with the following criteria:
◯: No change in the paint film.
Δ: Partial dissolution of the paint film.
x: Complete dissolution of the paint film.

(6) Water-Resistance

After being exposed outdoors for three months in accordance with JIS K-5400 (1900) 9.9, the color of the unwashed film surface of a test sheet was measured in accordance with the film color meter measurement method of JIS K-5400 (1900) 7.4.2, the ΔL* value was calculated by subtracting the L* value before the test from the L* value observed after immersing the test piece together with the film in hot water at 40° C. for 240 hours, and whitening of the film was evaluated. The results improve with a reduction in the value of ΔL*.

(7) Weather Resistance

The film condition was macroscopically observed after exposure for 3,000 hours using a sunshine carbon are lamp-type accelerated weather resistance tester (JIS K-5400 (1990) 9.8.1).

### Production Example 1

### Production of Solution A-1 of a Hydroxyl-Containing Resin Composition for a Coating Material

Xylene and 2,2-dimethylolbutanoic acid having the composition shown in Table 1 were introduced to a four-neck flask having a thermometer, reflux condenser, mixer, and dropping funnel; the mixture was heated while being stirred under a nitrogen current; and the product was kept at 140° C. Next, a mixture (component added drop-wise) of monomer and polymerization initiator having the composition shown in Table 1 was added at a temperature of 140° C. and a constant speed from the dropping funnel over a period of two hours. The temperature of 140° C. was maintained for one hour after drop-wise addition was completed, and then the reaction temperature was lowered to 110° C. A polymerization initiator solution (additional catalyst) having the composition shown in Table 1 was then added, the reaction was completed by maintaining a temperature of 110° C. for another two hours, and solution A-1 of a hydroxyl-containing resin composition for a coating material was obtained. The units of the numbers in the tables are all parts by weight.

### Production of Solution A-2 of Hydroxyl-Containing Resin Composition for a Coating Material

Xylene and 2,2-dimethylolbutanoic acid having the composition shown in Table 1 were introduced to a four-neck flask having a thermometer, reflux condenser, mixer, and dropping funnel; the mixture was heated while being stirred under a nitrogen current; and the product was kept at 140° C. Next, a mixture (component added drop-wise) of monomer and polymerization initiator having the composition shown in Table 1 was added at a temperature of 140° C. and a constant speed from the dropping funnel over a period of two hours. The temperature of 140° C. was maintained for one hour after drop-wise addition was completed, and then the reaction temperature was lowered to 110° C. A polymerization initiator solution (additional catalyst) having the composition shown in Table 1 was then added, a temperature of 110° C. was maintained for another two hours, ε-caprolactone was added in the amount shown in Table 1, the reaction was completed by maintaining a temperature of 150° C. for three hours, and solution A-2 of a hydroxyl-containing resin composition for a coating material was obtained.

TABLE 1

| | | Production | Production |
|---|---|---|---|
| | | Example 1 | Example 2 |
| Solution of hydroxyl-containing resin composition for coating | | A-1 | A-2 |
| material | | | |
| Initially introduced | Xylene | 60 | 60 |
| (parts by mass) | 2,2-Dimethylol-butanoic acid | 20 | 26 |
| Component added drop-wise | Glycidyl methacrylate | 20 | 25 |
| (parts by mass) | n-Butyl acrylate | 20 | 10 |
| | n-Butyl methacrylate | 20 | 19 |
| | 2-Ethylhexyl methacrylate | 20 | — |
| | t-Butylperoxy-2-ethylhexanoate | 2 | 2 |
| Additional catalyst (parts by mass) | t-Butylperoxy-2-ethylhexanoate | 0.2 | 0.2 |
| | Xylene | 4.5 | 2 |
| Additional component | ε-Caprolactam | — | 20 |
| (parts by mass) | Xylene | — | 2.5 |

| | | |
|---|---|---|
| Total (parts by mass) | 166.7 | 166.7 |
| Resin hydroxyl value (mg KOH/g) | 228 | 296 |
| Nonvolatile content (mass %) | 61.3 | 61.3 |
| Weight-average molecular weight | 12,000 | 14,000 |

### PRODUCTION EXAMPLE 3

### Production of Solution A-3 of a Hydroxyl-Containing Resin Composition for a Coating Material

Xylene having the composition shown in Table 2 was introduced to a four-neck flask having a thermometer, reflux condenser, mixer, and dropping funnel; the mixture was heated while being stirred under a nitrogen current; and the product was kept at 140° C. Next, a mixture (component added drop-wise) of monomer and polymerization initiator having the composition shown in Table 2 was added at a temperature of 140° C. and a constant speed from the dropping funnel over a period of two hours. The temperature of 140° C. was maintained for one hour after drop-wise addition was completed and then the reaction temperature was lowered to 110° C. A polymerization initiator solution (additional catalyst) having the composition shown in Table 2 was then added, the reaction was completed by maintaining a temperature of 110° C. for another two hours, and solution A-3 of hydroxyl-containing resin composition for a coating material was obtained.

### Production of Solution A-4 of a Hydroxyl-Containing Resin Composition for a Coating Material

Xylene having the composition shown in Table 2 was introduced to a four-neck flask having a thermometer, reflux condenser, mixer, and dropping funnel; the mixture was heated while being stirred under a nitrogen current; and the product was kept at 140° C. Next, a mixture (component added drop-wise) of monomer and polymerization initiator having the composition shown in Table 2 was added at a temperature of 140° C. and a constant speed from the dropping funnel over a period of two hours. The temperature of 140° C. was maintained for one hour after drop-wise addition was completed and then the reaction temperature was lowered to 110° C. A polymerization initiator solution (additional catalyst) having the composition shown in Table 2 was then added, a temperature of 110° C. was maintained for another two hours, 2,2-dimethylolbutanoic acid and ε-caprolactone were added in the amounts shown in Table 2, the reaction was completed by maintaining a temperature of 150° C. for three hours, and solution A-4 of a hydroxyl-containing resin composition for a coating material was obtained.

TABLE 2

| | | Production | Production |
|---|---|---|---|
| | | Example 3 | Example 4 |
| Hydroxyl-containing resin composition | | A-3 | A-4 |
| for coating material | | | |
| Initially introduced | Xylene | 60 | 60 |
| (parts by mass) | 2,2-Dimethylol-butanoic | — | — |
| | acid | | |
| Component added | Glycidyl methacrylate | 20 | 25 |
| drop-wise | n-Butyl acrylate | 20 | 10 |
| (parts by mass) | n-Butyl methacrylate | 20 | 19 |
| | 2-Ethylhexyl methacrylate | 20 | — |
| | t-Butylperoxy-2- | 2 | 2 |
| | ethylhexanoate | | |
| Additional catalyst | t-Butylperoxy-2- | 0.2 | 0.2 |
| (parts by mass) | ethylhexanoate | | |
| | Xylene | 4.5 | 2 |
| Additional | 2,2-Dimethylolbutanoic | 20 | 26 |
| component | acid | | |
| (parts by mass) | ε-Caprolactam | — | 20 |
| | Xylene | — | 2.5 |

| | | |
|---|---|---|
| Total (parts by mass) | 166.7 | 166.7 |
| Resin hydroxyl value (mg KOH/g) | 228 | 296 |
| Nonvolatile content (mass %) | 61.3 | 61.3 |
| Weight-average molecular weight | 13,000 | 15,000 |

### WORKING EXAMPLES 5 THROUGH 7

### Production of Solutions A-5 Through A-8 of Hydroxyl-Containing Resin Composition for a Coating Material

With the exception that the starting materials were as in Table 3, solutions A-5 through A-8 of comparative hydroxyl containing resin compositions for a coating material were obtained as in Production Examples 1.

TABLE 3

| | | Production | Production | Production | Production |
|---|---|---|---|---|---|
| | | Example 5 | Example 6 | Example 7 | Example 8 |
| Hydroxyl-containing resin composition for | | A-5 | A-6 | A-7 | A-8 |
| coating material | | | | | |
| Initially introduced | Xylene | 60 | 60 | 60 | 60 |
| (parts by mass) | Propionic acid | — | — | — | 10 |
| Component | Glycidyl methacrylate | — | — | — | 20 |
| added drop-wise | 2-Hydroxyethyl | 40 | 51 | 22 | 10 |
| (parts by mass) | methacrylate | | | | |
| | n-Butyl acrylate | 20 | 10 | 29 | 20 |
| | n-Butyl methacrylate | 20 | 19 | 29 | 20 |
| | 2-Ethylhexyl methacrylate | 20 | — | 20 | 20 |
| | t-Butylperoxy-2- | 2 | 2 | 2 | 2 |
| | ethylhexanoate | | | | |
| Additional Catalyst | t-Butylperoxy-2- | 0.2 | 0.2 | 0.2 | 0.2 |
| (parts by mass) | ethylhexanoate | | | | |
| | Xylene | 4.5 | 2 | 2 | 2 |
| Additional | ε-Caprolactam | — | 20 | — | — |
| Component | Xylene | — | 2.5 | 2.5 | 2.5 |
| (parts by mass) | | | | | |

| | | | | |
|---|---|---|---|---|
| Total (parts by mass) | 166.7 | 166.7 | 166.7 | 166.7 |
| Resin hydroxyl value (mg KOH/g) | 173 | 220 | 95 | 119.5 |
| Nonvolatile content (mass %) | 61.3 | 61.3 | 61.3 | 61.3 |
| Weight-average molecular weight | 10,000 | 11,000 | 12,000 | 13,000 |

### PRODUCTION EXAMPLES 9 THROUGH 17

### Production of Clear Coating Materials CC-1 Through 9

The starting materials listed in Tables 4 through 5 were gradually mixed and stirred until uniform to produce clear coating materials.

TABLE 4

| | Production | Production | Production | Production |
|---|---|---|---|---|
| | Example 9 | Example 10 | Example 11 | Example 12 |
| Clear Paint | CC-1 | CC-2 | CC-3 | CC-4 |
| Hydroxyl-containing resin solution A-1 | 100 | 100 | — | — |
| Hydroxyl-containing resin solution A-2 | — | — | 105 | — |
| Hydroxyl-containing resin solution A-3 | — | — | — | 100 |
| Hydroxyl-containing resin solution A-4 | — | — | — | — |
| Hydroxyl-containing resin solution A-5 | — | — | — | — |
| Hydroxyl-containing resin solution A-6 | — | — | — | — |
| Hydroxyl-containing resin solution A-7 | — | — | — | — |
| Hydroxyl-containing resin solution A-8 | — | — | — | — |
| Crosslinking agent Yuban SE-60³⁾ | 30 | — | 25 | 30 |
| Crosslinking agent Desmodur N3200²⁾ | — | 60 | — | — |
| UV absorber solution³⁾ | 7 | 7 | 7 | 7 |
| Photostabilizer solution⁴⁾ | 7 | 7 | 7 | 7 |
| Surface modifier solution⁶⁾ | 2 | 2 | 2 | 2 |
| Solvesso 100⁶⁾ | 15 | 15 | 15 | 15 |
| Total (parts by mass) | 161 | 191 | 161 | 161 |
| Hydroxyl-containing resin solid content (parts by | 61.3 | 61.3 | 64.4 | 61.3 |
| mass) | | | | |
| Crosslinking agent solid content (parts by mass) | 18 | 60 | 15 | 18 |
| Hydroxyl-containing resin/crosslinking agent (solid | 77.3/ | 50.5/ | 81.2/ | 77.3/ |
| content mass ratio) | 22.7 | 49.5 | 18.8 | 22.7 |

TABLE 5

| | Production | Production | Production | Production | Production |
|---|---|---|---|---|---|
| | Example | Example | Example | Example | Example |
| | 13 | 14 | 15 | 16 | 17 |
| Clear Paint | CC-5 | CC-6 | CC-7 | CC-8 | CC-9 |
| Hydroxyl-containing resin solution A-1 | — | — | — | — | — |
| Hydroxyl-containing resin solution A-2 | — | — | — | — | — |
| Hydroxyl-containing resin solution A-3 | — | — | — | — | — |
| Hydroxyl-containing resin solution A-4 | 105 | — | — | — | — |
| Hydroxyl-containing resin solution A-5 | — | 100 | — | — | — |
| Hydroxyl-containing resin solution A-6 | — | — | 100 | — | — |
| Hydroxyl-containing resin solution A-7 | — | — | — | 80 | — |
| Hydroxyl-containing resin solution A-8 | — | — | — | — | 85 |
| Crosslinking agent Yuban SE-60¹⁾ | 25 | 30 | 30 | 50 | 45 |
| Crosslinking agent Desmodur N3200²⁾ | — | — | — | — | — |
| UV absorber solution³⁾ | 7 | 7 | 7 | 7 | 7 |
| Photostabilizer solution⁴⁾ | 7 | 7 | 7 | 7 | 7 |
| Surface modifier solution⁵⁾ | 2 | 2 | 2 | 2 | 2 |
| Solvesso 100⁶⁾ | 15 | 15 | 15 | 15 | 15 |
| Total (parts by mass) | 161 | 161 | 161 | 161 | 161 |
| Hydroxyl-containing resin solid content | 64.4 | 61.3 | 61.3 | 49.0 | 52.1 |
| (parts by mass) | | | | | |
| Crosslinking agent solid content (parts by | 15 | 18 | 18 | 30 | 27 |
| mass) | | | | | |
| Hydroxyl-containing resin/crosslinking | 81.2/ | 77.3/ | 77.3/ | 61.8/ | 65.7/ |
| agent (solid content mass ratio) | 18.8 | 22.7 | 22.7 | 38.2 | 34.3 |

[Table 4 and Table 5 notes]
¹⁾Yuban 20ES-60: Trade name, melamine resin solution (nonvolatile content of 60 mass %), Mitsui Chemicals
²⁾Desmodur N3200: Trade name, biuret resin of liquid HDI (nonvolatile content of 100 mass %, NCO content of 23 mass %), Sumika Bayer Urethane Co., Ltd.
³⁾Tinuvin 900: Trade name, UV absorber (20 mass % xylene solution), Ciba Specialty Chemicals
⁴⁾Tinuvin 292: Trade name, photostabilizer (20 mass % xylene solution), Ciba Specialty Chemicals
⁵⁾BYK-300: Trade name, surface modifier (10 mass % xylene solution), BYK Chemie
⁶⁾Solvesso 100: Trade name, aromatic petroleum naphtha, produced by the Esso Co., Ltd.

### WORKING EXAMPLES 1 THROUGH 5

### Production of Test Piece and Film Property Tests

The cationic electrodeposition coating material Aqua No. 4200 (trade name, BASF NOF Coatings) was electrodeposited onto a lead phosphate-treated soft steel sheet in a dry film thickness of 20 μm, the product was dried for 25 minutes at 175° C., middle coating material HS-H300 (trade name, BASF NOF coatings) was applied by air spraying in a dry film thickness of 30 μm, and the product was dried for 30 minutes at 140° C. Next, Belcoat No. 6000 white (trade name, BASF NOF coatings; color: white), which is a solvent-based base coat material, was applied by air spraying in a dry film thickness of 15 μm and set for three minutes at 20° C. Then clear coating materials CC-1 through 5 were diluted to application viscosity (25 seconds at 20° C. with Ford cup No. 4) using Solvesso 100 (trade name, Esso Co., Ltd., aromatic petroleum naphtha) and applied by air spraying using the wet-on-wet system in a dry film thickness of 40 μm, the product was dried at 140° C. for 30 minutes, and a test piece was made.

The base coat material was changed to Belcoat No. 6000 black (trade name, BASF NOF Coatings, color: black) only for the water resistance test sheets in Working Examples 1 through 5.

The film properties are shown in Table 6. In each case, there was no turbidity of the coating materials; a uniform, glossy film was obtained; and appearance, acid rain resistance, car-washing damage resistance, water resistance, solvent resistance, and weather resistance were excellent.

TABLE 6

| | Example 1 | Example 2 | Example 3 | Example 4 | Example 5 |
|---|---|---|---|---|---|
| Clear coating material | CC-1 | CC-2 | CC-3 | CC-4 | CC-5 |
| Coating material turbidity | ◯ | ◯ | ◯ | ◯ | ◯ |
| Appearance | ◯ | ◯ | ◯ | ◯ | ◯ |
| Acid rain resistance | ◯ | ◯ | ◯ | ◯ | ◯ |
| Car-washing damage | ◯ | ◯ | ◯ | ◯ | ◯ |
| resistance | | | | | |
| Water resistance | 0.3 | 0.2 | 0.5 | 0.4 | 0.3 |
| Solvent resistance | ◯ | ◯ | ◯ | ◯ | ◯ |
| Weather resistance | No | No | No | No | No |
| | anomalies | anomalies | anomalies | anomalies | anomalies |

### COMPARATIVE EXAMPLES 1 THROUGH 4

With the exception that CC-6 through 9 were used for the clear coating material, a test piece was produced as in Working Example 1.

The film properties are shown in Table 7. In Comparative Examples 1 and 2, compatibility between the primary resin, crosslinking agent, and solvent was poor, the paint was turbid, and there was a considerable reduction in glossy appearance. Moreover, although a uniform, glossy film was obtained with no turbidity of the coating material in Comparative Example 3, acid rain resistance and car-washing damage resistance were inferior. There was a reduction in acid rain resistance, car-washing damage resistance, and water resistance in Comparative Example 4.

TABLE 7

| | Comparative | Comparative | Comparative | Comparative |
|---|---|---|---|---|
| | Example 1 | Example 2 | Example 3 | Example 4 |
| Clear coating material | CC-6 | CC-7 | CC-8 | CC-9 |
| Coating material turbidity | X | X | ◯ | ◯ |
| Appearance | X | X | ◯ | Δ |
| Acid rain resistance | ◯ | ◯ | X | Δ |
| Car-washing damage resistance | ◯ | X | Δ | ◯ |
| Water resistance | 0.5 | 0.8 | 1.4 | 1.1 |
| Solvent resistance | ◯ | ◯ | ◯ | ◯ |
| Weather resistance | No anomalies | No anomalies | No anomalies | No anomalies |

1. A resin composition comprising a hydroxyl group containing resin obtained by copolymerizing a radically polymerizable monomer (b) comprising an epoxy group, and a radically polymerizable monomer (c), in the presence of an acid compound (a) which has one carboxyl group and two or more hydroxyl groups, wherein the hydroxyl group containing resin comprises a hydroxyl group value of from 50 to 400 mgKOH/g and a weight average molecular weight of from 2,000 to 100,000.

2. A resin composition comprising a hydroxyl group containing resin obtained by subjecting a copolymer of a radically polymerizable monomer (b) which has an epoxy group, and a radically polymerizable monomer (c) to an addition reaction with an acid compound (a) which has one carboxyl group and two or more hydroxyl groups, wherein the hydroxyl group containing resin comprises a hydroxyl group value of from 50 to 400 mgKOH/g and a weight average molecular weight of from 2,000 to 100,000.

3. The resin composition of claim 1 wherein the acid compound (a) comprises 2,2-dimethylolbutanoic acid or 2,2-dimethylolpropionic acid.

4. The resin composition of claim 1 wherein the 100 parts by mass of the hydroxyl group containing resin of claim 1 is subjected to an addition reaction with less than 100 parts by mass of a lactone compound (d).

5. A coating composition comprising resin composition of claim 1 and a crosslinking agent containing within each molecule at least one functional group which reacts with hydroxyl groups.

6. A method of coating a substrate comprising applying the coating composition of claim 5 to a substrate.

7. A coated substrate made by the method of claim 6.

8. The resin composition of claim 2 wherein the acid compound (a) which has one carboxyl group and two or more hydroxyl groups comprises 2,2-dimethylolbutanoic acid or 2,2-dimethylolpropionic acid.

9. The resin composition of claim 2 wherein 100 parts by mass of the hydroxyl group containing resin is subjected to an addition reaction with less than 100 parts by mass of a lactone compound (d).

10. A coating composition comprising the resin composition of claim 2 and a crosslinking agent containing within each molecule at least one functional group which reacts with hydroxyl groups.

11. A method of coating a substrate comprising applying the coating composition of claim 10 to a substrate.

12. A coated substrate made by the method of claim 11.

13. A method of making a hydroxyl containing resin composition comprising copolymerizing a radically polymerizable monomer comprising an epoxy group (b) and a radically polymerizable monomer (c), in the presence of an acid compound which has one carboxyl group and two or more hydroxyl groups (a), (b) (c), wherein the hydroxyl group containing resin comprises a hydroxyl group value of from 50 to 400 mgKOH/g and a weight average molecular weight of from 2,000 to 100,000.

14. A method of making a hydroxyl containing resin composition comprising subjecting a copolymer or a radically polymerizable monomer which has an epoxy group (b) and a radically polymerizable monomer (c) to an addition reaction with an acid compound which has one carboxyl group and two or more hydroxyl groups (a), wherein the hydroxyl group containing resin comprises a hydroxyl group value of from 50 to 400 mgKOH/g and a weight average molecular weight of from 2,000 to 100,000.
